(19) United States
(12) Patent Application Publication
(10) Pub. No.: US 2019/0041885 A1
(43) Pub. Date: Feb. 7, 2019

(54) ADAPTIVE BULK-BIAS TECHNIQUE TO IMPROVE SUPPLY NOISE REJECTION, LOAD REGULATION AND TRANSIENT PERFORMANCE OF VOLTAGE REGULATORS

(71) Applicant: Vidatronic Inc., College Station, TX (US)

(72) Inventors: He Hu, Bryan, TX (US); FAISAL ABDELATIF ELSEDEEK HUSSIEN, Cairo (EG)

(73) Assignee: Vidatronic Inc., College Station, TX (US)

(21) Appl. No.: 15/667,619

(22) Filed: Aug. 2, 2017

(51) Int. Cl. G05F 1/575; G05F 1/565; G05F 1/46; G05F 1/445

(52) U.S. Cl. CPC G05F 1/575; G05F 1/445; G05F 1/467; G05F 1/565

(57) ABSTRACT

A low-dropout (LDO) voltage regulator includes an adaptive bias source for generating a bulk-bias signal to a pass device in the LDO voltage regulator, wherein the adaptive bias source generates the bulk-bias signal based on a signal obtained at an output of the LDO voltage regulator. The signal includes a current signal, which is proportional to a current at the output of the LDO voltage regulator, and/or a feedback signal from a feedback path connected between the adaptive bias source and the output of the LDO voltage regulator for sensing negative and/or positive spikes.

### FIELD OF INVENTION

The present invention relates to linear voltage regulators, particularly to bulk-biased linear voltage regulators.

### BACKGROUND

The demands for portable electronics, such as smart phones, bluetooth headphones and so on, are growing fast. Since most of these devices integrate many power supply-sensitive circuits onto a single integrated chip, a constant, clean and accurate supply is very necessary. Linear voltage regulators (e.g. Low Drop-Out (LDO) regulators) can provide a well-specified and stable dc-voltage. They are also widely-used in the integrated System-on-Chip (SoC) designs, which require power management circuits to optimize the power consumption of different analog, digital or Radio Frequency (RF) blocks independently. Throughout this disclosure, the terms “LDO linear voltage regulator” and “LDO” may be used interchangeably depending on the context.

The area, voltage conversion efficiency, and load transient response performance are critical properties of LDO regulators. Since most portable devices are distinguished by small sizes and low energy consumption, power management circuits like LDO regulators are required to occupy small area of the printed circuit board (PCB) or even integrated with other circuits on the same chip. On the other hand, since most mobile electronics use batteries as their only power source, the battery life time becomes one of the main concerns. The conversion efficiency of a power management circuit directly affects the battery life time. As linear regulators, LDOs, can only generate supply voltages lower than the batteries' output voltages. The voltage conversion efficiency of an LDO circuit can be calculated according to equation (1), assuming negligible quiescent current consumption by the LDO circuitry.

$$η = \frac{{V}_{out} ( Output voltage of the LDO )}{{V}_{i n} ( Input voltage from the external supply )} = 1 - \frac{{V}_{i n} - {V}_{out}}{{V}_{i n}} = 1 - \frac{{V}_{DO}}{{V}_{i n}} \\ where , {V}_{DO} = {V}_{i n} - {V}_{out} . \qquad ( 1 )$$

From the above equation, it is clear that the smaller the dropout voltage (V_{DO}) of an LDO regulator (the difference between input voltage and output voltage of the LDO) is, the higher the voltage conversion efficiency is. However, the smaller dropout requires an area increase of the power device (pass device) of the LDO. This results in an efficiency-area tradeoff. Moreover, as the technology advances, the sizes of CMOS devices become smaller and the maximum allowed voltages for the circuits built by these devices are also becoming much lower. Thus, the expected voltage variation at the gate of the pass device is limited. This results in a limited current capability for a given device size, if controlled only by its gate voltage. In addition, the outputs of the LDO regulators are expected to be stable when the load currents change. The overshoot/undershoot of the output voltage should be as small as possible. These new application requirements on LDO regulators present great challenges for circuit designers.

Bulk bias techniques have been used in the design of LDO regulators to reduce the chip size, while maintaining the same performance as the conventional LDO regulators. Equation (2) represents a relationship between the threshold voltage (V_{TH}) of a PMOS transistor and its bulk to source voltage (V_{BS}) as an example of the effect of bulk voltage:

V_{TH}=V_{TH0}−γ(\sqrt{|2ϕ_{F}|+V_{BS}}−\sqrt{|2ϕ_{F}|}) (2),

where V_{TH0} represents the threshold voltage with V_{BS}=0, and γ and ϕ_{F} are technology-dependent parameters for a p-channel transistor.

As shown in Equation (2), a forward bulk bias voltage (Positive V_{BS}) will lower the threshold voltage (V_{TH}) of the pass device in the LDO regulator. In an example disclosed by Y. S. Koo (“A design of low-area low drop-out regulator using body bias technique,” IEICE Electronics Express 10, No. 19 (2013): 20130300-20130300), a forward bulk bias is used to lower the V_{TH} and reduce the transistor size within a certain current range. The bulk of the pass transistor of this LDO regulator is adaptively-biased with the input supply (its voltage is a constant shift of the input supply voltage), but it is constant with the load current. In an example disclosed by H. E. Cho and Y. S. Koo (“A Design of Wide-Bandwidth LDO Regulator with High Robustness ESD Protection Circuit.” Journal of Power Electronics 15, no. 6 (2015): 1673-1681), the LDO regulator also employs a forward bulk-biased voltage to lower the V_{TH}, but it also uses a constant bias voltage.

Although, achieving a silicon area improvement for the same current capability, the above improvements did not address the following:
1. The bulk-bias voltage improves the current capability for a given device size. This is achieved by reducing the required gate-source voltage to supply a certain output current. As a result, the maximum allowed gate voltage can generate more output currents for the same device using bulk-bias technique. At low output currents, the bulk bias is not required, nor is it effective. On the other hand, at low output currents, the bulk bias degrades the Power Supply Rejection (PSR) of the LDO.
2. The load regulation performance of the LDO regulators using a constant bulk-bias voltage becomes worse than that of a conventional LDO regulator without bulk-bias technique.
3. At small load currents, a small gate to source voltage (V_{GS}) of the pass transistor is required to maintain the output current. If the bulk-bias voltage is added to the transistor, the lower threshold voltage will make this V_{GS} even smaller. On the other hand, the maximum V_{GS} is still required for maximum output current. This leads to more stress on the output range of the error amplifier design.

### SUMMARY OF THE INVENTION

Embodiments of the invention relate to voltage regulators that use adaptive bulk-bias techniques to improve their PSR, load regulation, and load transient performance on top of the output current capability. The adaptive bulk-bias techniques can overcome the problems related to the prior art techniques mentioned above.

PSR, load transient response, and maximum output current are important performance parameters of an LDO regulator. Prior improvement methods usually focused on one of these factors. The adaptive bulk-bias technique disclosed in the present invention is capable of improving multiple or all these parameters of an LDO regulator.

First, the adaptive bulk-bias technique lowers the threshold (Vₜₕ) of the pass transistor of an LDO regulator, resulting in increased output current capability without making other changes to the LDO regulator. Second, in a fast load transition process, the output voltage of the error amplifier of an LDO regulator does not need to change too much due to a lowered threshold of the pass transistor. As a result, the load transient response of the LDO is improved. Third, the adaptive bulk-biased technique increases the output impedance (Rₒᵤₜ) of the LDO regulator when the load is high, which improves its PSR in the high load situation. Finally, a combination adaptive bulk-bias scheme can further improve the load transient performance of an LDO regulator. A combination adaptive bulk-bias scheme combines both a fast and a slow bias signal paths to compensate for output spikes caused by the fast load transition.

One aspect of the invention relates to ow-dropout (LDO) voltage regulators. An LDO regulator in accordance with one embodiment of the invention includes an adaptive bias source for generating a bulk-bias signal to a pass device in the LDO voltage regulator, wherein the adaptive bias source generates the bulk-bias signal based on a signal obtained at an output of the LDO voltage regulator.

In accordance with embodiments of the invention, the signal may include a current signal, which is proportional to a current at the output of the LDO voltage regulator, and/or a feedback signal from a feedback path connected between the adaptive bias source and the output of the LDO voltage regulator for sensing negative and/or positive spikes.

One aspect of the invention relates to methods for voltage regulation using a low dropout (LDO) voltage regulator that comprises an adaptive bias source connected to a pass device. A method in accordance with one embodiment of the invention comprises: sensing a signal at an output of the LDO voltage regulator; generating a bulk-bias signal from the adaptive bias source based on a magnitude of the signal sensed at the output; and supplying the bulk-bias signal to the pass device to regulate the voltage at the output of the LDO voltage regulator.

In accordance with embodiments of the invention, the signal may comprise a current signal, which is proportional to a current at the output, and/or a feedback signal that relates to negative and/or positive spikes at the output.

Other aspects of the invention will be apparent from the following detailed description and the appended claims.

### BRIEF DESCRIPTION OF DRAWINGS

FIG. 1 shows a proposed adaptive bulk-bias technique for a typical PMOS LDO regulator in accordance with one embodiment of the invention.

FIG. 2 shows regulator output voltage versus its output current.

FIG. 3 shows regulator error amplifier output voltage versus regulator output current

FIG. 4 shows a typical PSR behavior of a linear voltage regulator in accordance with one embodiment of the invention.

FIG. 5 shows the PSR curves of a conventional LDO regulator and an LDO regulator using the adaptive bulk-bias technique in accordance with one embodiment of the invention, both of their pass transistors are working in the saturation region.

FIG. 6 shows PSR of a typical voltage regulator at low output current.

FIG. 7 shows the load transient responses of a conventional LDO versus an LDO using adaptive bulk-bias technique.

FIG. 8 shows an LDO regulator using the transient adaptive bulk-bias technique in accordance with one embodiment of the invention.

FIG. 9 shows the load transient responses of a conventional LDO regulator and an LDO regulator using the transient adaptive bulk-bias technique in accordance with one embodiment of the invention.

FIG. 10 shows an LDO regulator using the combinational adaptive bulk-bias technique in accordance with one embodiment of the invention.

FIG. 11 shows the load transient responses of a conventional LDO regulator and an LDO regulator using the combinational adaptive bulk-bias technique in accordance with one embodiment of the invention.

### DETAILED DESCRIPTION

Embodiments of the present invention are illustrated with the above-identified drawings and the following description. In the description, like or identical reference numerals are used to identify common or similar elements. The drawings are not necessarily to scale and certain features may be shown exaggerated in scale or in schematic in the interest of clarity and conciseness.

Embodiments of the invention relate to an inventive method to improve the power supply rejection (PSR), load regulation, and load transient performance of voltage regulators by adding a load-adaptive bulk-bias to the pass devices of voltage regulators.

Because a strong forward bulk-bias voltage can lead to a high leakage current through the p-n junction diode in the pass devices (p-channel or n-channel MOSFETs), the value of this bulk-bias voltage is limited to a certain value in order to prevent this high leakage current. Simulation and experiments can be performed to obtain this maximum bulk-bias limit for devices of different technologies.

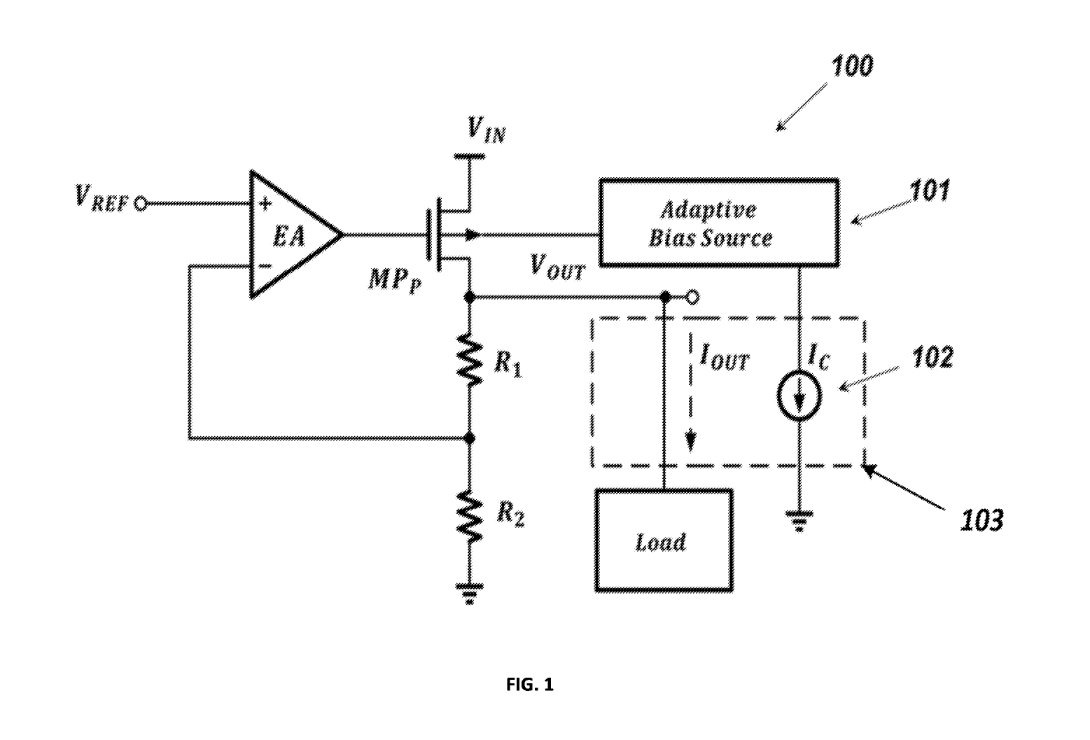

FIG. 1 shows a typical PMOS pass device LDO regulator with an adaptive forward bulk-bias voltage in accordance with one embodiment of the invention. A current controlled current source (102) senses the load current (I_{OUT}) of the LDO (current mirror operation) and generates a current signal (I_{C}), which is proportional to I_{OUT}. An adaptive bias source (101) generates a bias voltage according to the magnitude of I_{C}. When the output current is minimum, the bulk-bias voltage is zero; when the output current is maximum, the bulk-bias voltage reaches the maximum limit. This circuit is just an implementation example. One skilled in the art would appreciate that other modifications and variations are possible without departing from the scope of the invention. For example, a different sensing techniques (103) can be used to extract the output current information and inject a voltage equivalent value into the pass device bulk. Similarly, same method and/or idea may be applied to voltage regulators (switching and linear) using different pass devices (PMOS, NMOS, PFET, NFET, PFIN, and NFIN).

When the output current of an LDO regulator is moderate or high, the pass device works in the saturation or linear region of MOS transistor. Its drain current (ID), the gate to source voltage (V_{GS}), and drain to source voltage (V_{DS}) are related by equations (3) and (4).

$$\begin{matrix}{I}_{D} = {μ}_{n} {C}_{ox} \frac{W}{L} ( ( {V}_{GS} - {V}_{th} ) {V}_{DS} - \frac{{V}_{DS}^{2}}{2} ) , ( in linear region ) , & ( 3 ) \\ {I}_{D} = \frac{{μ}_{n} {C}_{ox}}{2} \frac{W}{L} {( {V}_{GS} - {V}_{th} )}^{2} [ 1 + λ ( {V}_{DS} - {V}_{DSsat} ) ] , \\ ( in saturation region ) , & ( 4 )\end{matrix}$$

where μₙ is the charge-carrier effective mobility, W is the gate width, L is the gate length, Cₒₓ is the gate oxide capacitance per unit area, λ is the channel-length modulation parameter, I_{D} is the drain current of the device, V_{GS} is the gate-to-source voltage, Vₜₕ is the threshold voltage of the device, V_{GS} is the drain-to-source voltage and V_{DSsat} is the saturation voltage, which equals V_{GS}-Vₜₕ.

Adding a bulk-bias voltage to the pass device, Vₜₕ will decrease as mentioned in the background section. No matter whether the pass device works in the linear region or in the saturation region, a drop in Vₜₕ will increase I_{D}, which is also the output current of the LDO regulator, while other parameters like area (W and L) and V_{GS} maintain their original values. Another benefit is that V_{DSsat} (V_{DS} in the saturation region) also decreases due to the reduction of Vₜₕ. Thus, the dropout of the LDO regulator can be smaller than that of the LDO regulator without bulk-bias. For many applications in which external supply voltage is very close to the output voltage of the LDO regulators (small headroom), this improvement is very helpful.

In accordance with embodiments of the invention, one or more of the modules and elements shown in the example of FIG. 1 may be omitted, repeated, and/or substituted. Accordingly, embodiments of the invention should not be considered limited to the specific arrangements of modules shown in the example of FIG. 1.

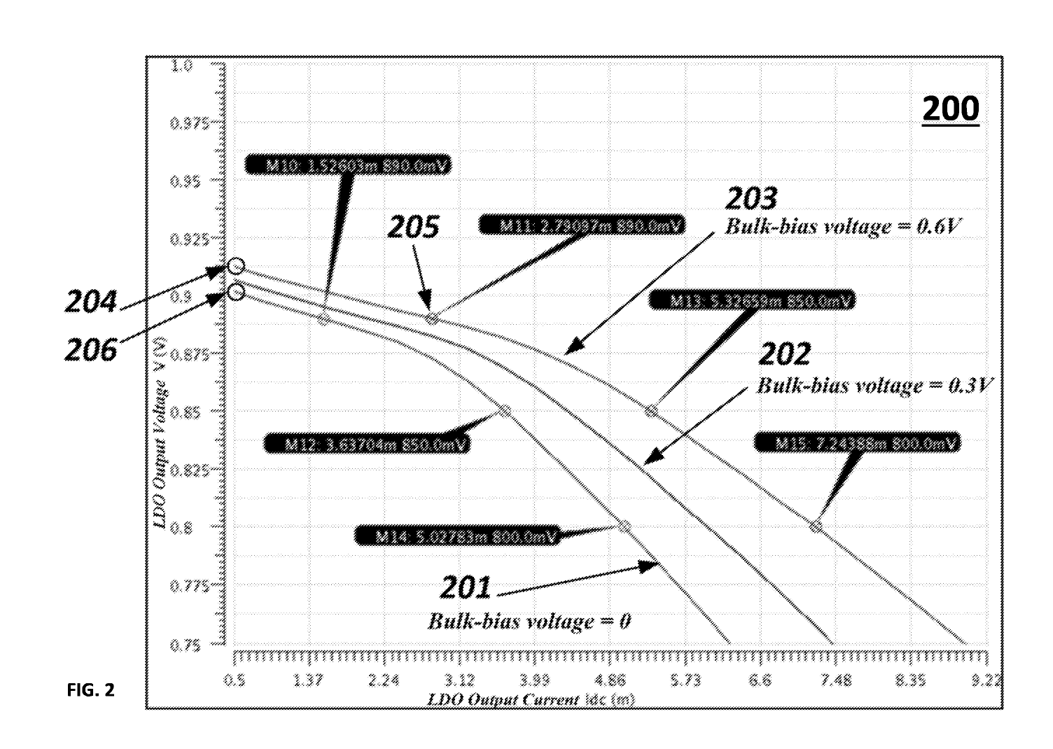

FIG. 2 presents the simulation results of a typical regulator showing the regulator output voltage versus the regulator output current for different bulk voltages. Zero-bulk bias curve (201) corresponds to a conventional regulator with its pass device bulk connected to the pass device source. While 0.3V and 0.6V curves (202, 203) correspond to V_{BS} of 0.3V and 0.6V, respectively, for the pass device of the regulator. Zero-bulk bias (201) can support a maximum current of 1.5 mA while maintaining the output voltage above 0.89V, whereas the 0.6V bulk bias (203) can support a maximum current up to 2.79 mA while maintaining the same output voltage and for the same pass device size. On the other hand, 0.6V bulk bias (203) results in a load regulation of 225 mV as the output current changes from 0.5 mA to 2.79 mA, moving from (204) to (205). Using adaptive bias, the load regulation is reduced by 100 mV only, moving from (206) to (205). Thus, the adaptive biasing helps DC load regulation.

As noted above, using a bulk bias helps the gate voltage to increase the pass device current capability. At the same time, it reduces the required gate voltage at low output current value. This results in an increase in the dynamic range of the gate voltage, which may add more requirements on the error amplifier design.

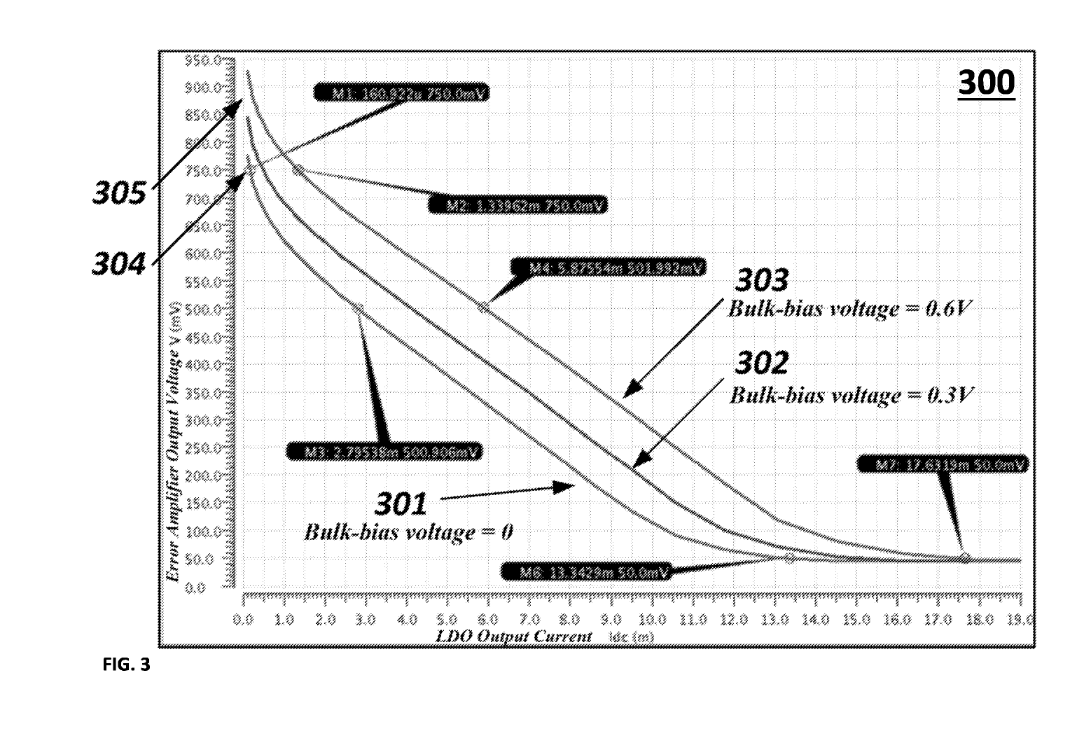

FIG. 3 presents the simulation results of a typical LDO showing the error amplifier output voltage versus the output current for different bulk voltages. Zero-bulk bias curve (301) corresponds to a conventional regulator with its pass device bulk connected to the pass device source. While 0.3V and 0.6V curves (302, 303) correspond to V_{BS} of 0.3V and 0.6V, respectively, for the pass device of the regulator. Zero-bulk bias (301) has a maximum error amplifier output voltage of 750 mV at 160 μA (304), while the 0.6V bulk bias (303) has a maximum error amplifier output voltage of 900 mV (305) at 160 μA. Using adaptive bulk bias relaxes the requirement on the error amplifier output, especially at low supply conditions.

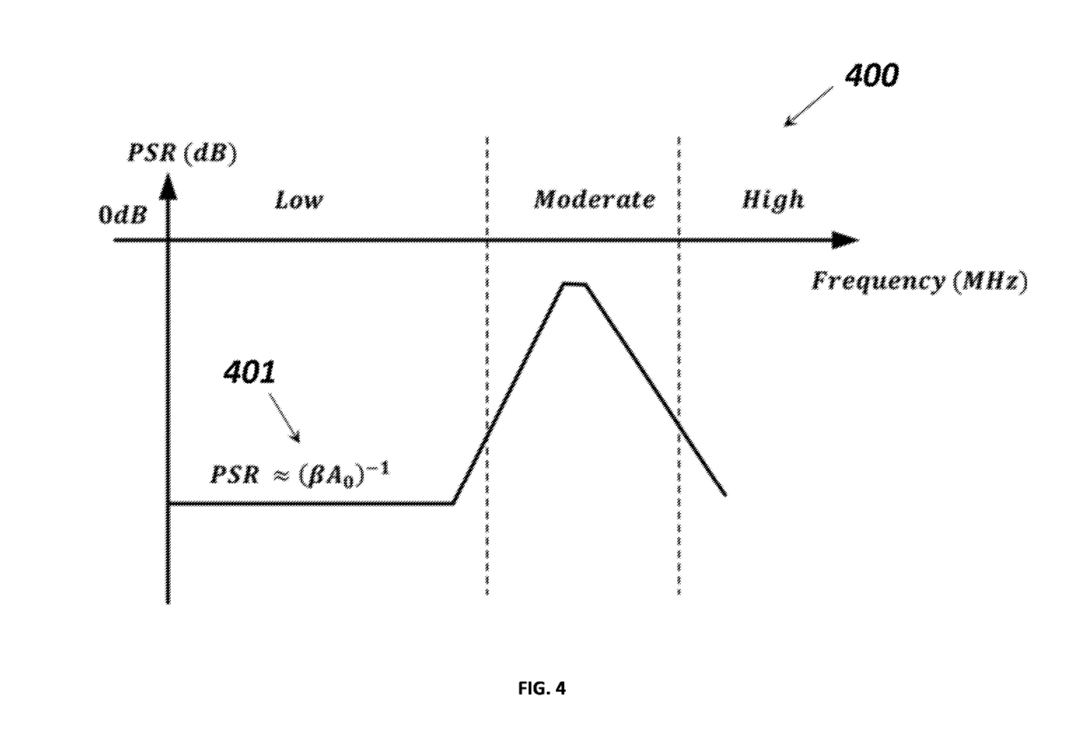

Power supply rejection (PSR) of an LDO regulator can be improved by adding bulk-bias to the pass device. FIG. 4 shows a typical PSR behavior of a linear voltage regulator: β is the feedback ratio, A₀ is the total gain of error amplifier and pass device. In the low frequency range, the PSR is determined by the loop gain (βA₀) of the LDO main loop. When the pass transistor is working in the saturation region, the contribution of the pass transistor to the loop gain can be represented by the equation (5).

$${A}_{pass} = {g}_{m} {R}_{out} = \frac{2 ( {R}_{1} + {R}_{2} )}{λ ( {R}_{1} + {R}_{2} + \frac{1}{λ {I}_{D}} ) ( {V}_{GS} - {V}_{TH} )} , \qquad ( 5 )$$

where gₘ is the transconductance of the pass device, Rₒᵤₜ is the output impedance of the LDO, R₁ and R₂ are the resistors of the potential divider of the LDO.

It can be seen as V_{TH} is lowered by adding a bulk-bias voltage, the gain of the pass device will increase, which improves the PSR of the LDO regulator at low frequency.

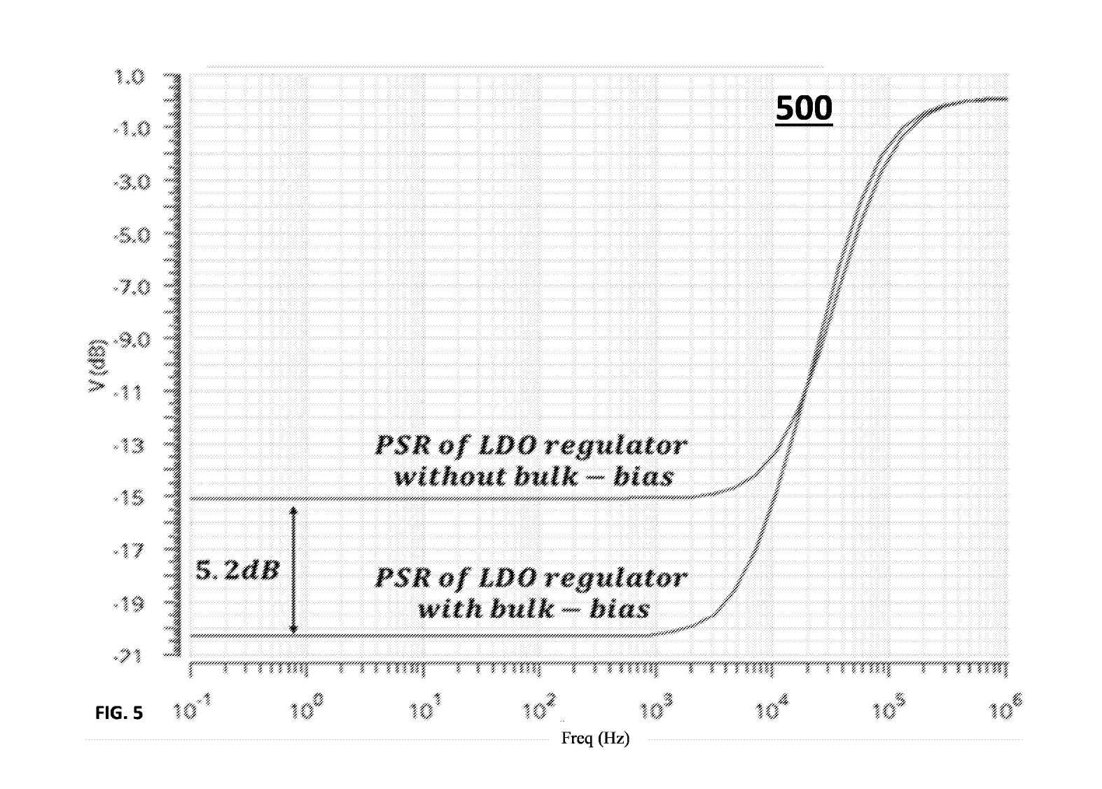

FIG. 5 shows the effect of the bulk-bias on the PSR of an LDO regulator at 5 mA output current. When the bulk-bias is added to the pass device, the PSR at the low frequency is improved by 5.2 dB. Table. 1 shows the PSR of an LDO regulator with bulk-bias at low frequency range. In this simulation, V_{IN} is 1.1V, V_{OUT} is 0.9V, I_{OUT} is 5 mA. As bulk-bias voltage increases, the PSR of the LDO regulator at maximum current is improved.

TABLE 1
PSR of a bulk-biased LDO regulator at 10 Hz
and 1000 Hz at 5 mA regulator output current.

| | | Bulk-bias voltage (mV) | | | | | | |
|---|---|---|---|---|---|---|---|---|
| PSR (dB) | | 0 | 81 | 162 | 243 | 324 | 405 | 486 |
| Frequency | 10 | −15.1 | −16.6 | −17.8 | −18.6 | −19.4 | −19.9 | −20.4 |
| (Hz) | 1000 | −15.1 | −16.6 | −17.8 | −18.6 | −19.3 | −19.9 | −20.3 |

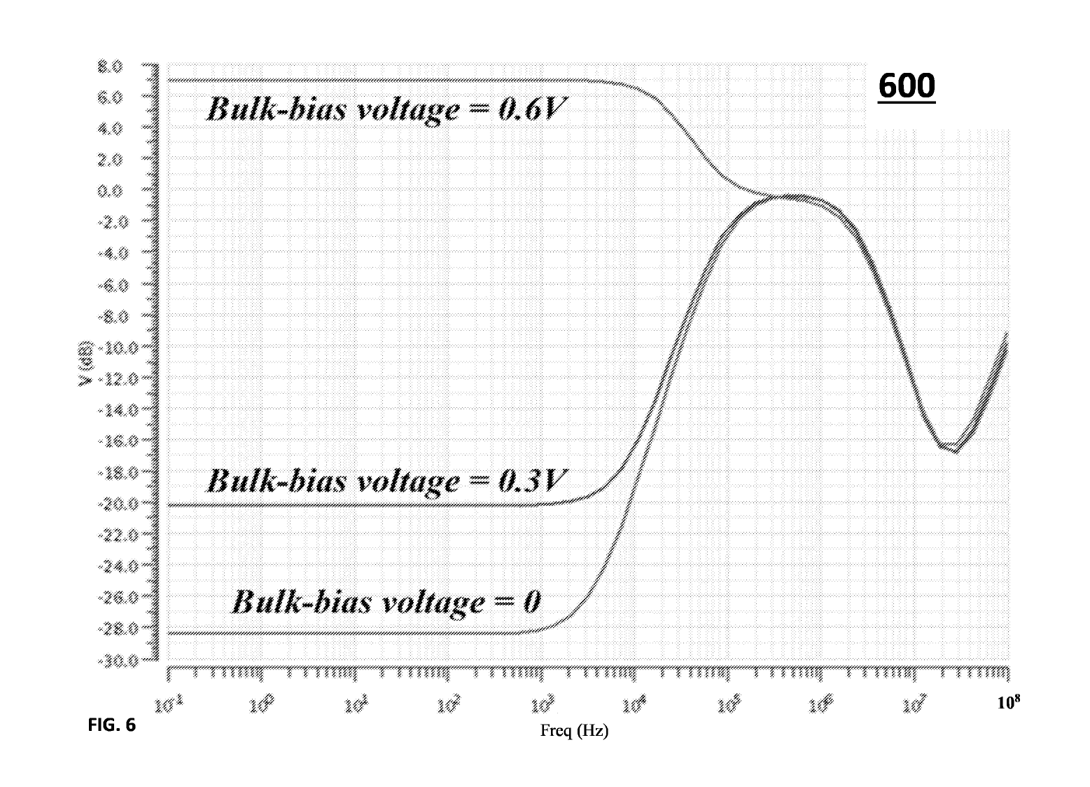

However, bulk bias technique degrades the PSR performance of a voltage regulator at low output current values. FIG. 6 shows the PSR curves for a typical PMOS LDO with different bulk bias voltages at low output current. A low frequency PSR degradation can be easily noticed due to bulk bias.

In accordance with embodiments of the invention, using an adaptive bulk-bias technique injects a zero bulk bias voltage at low output currents, while injecting a higher bulk bias voltage at high output currents, thereby achieving optimum PSR across all output current variations.

The load transient response of an LDO regulator can also be improved by adding a forward adaptive bulk-bias to the pass device. When the load current changes, voltage overshoots and undershoots are usually produced on the output of an LDO regulator. The amplitudes of the overshoots and undershoots are affected by the V_{GS} voltage difference of the pass device before and after the load current changes. If the difference is small, then when other parameters are the same, the overshoots and undershoots will be small.

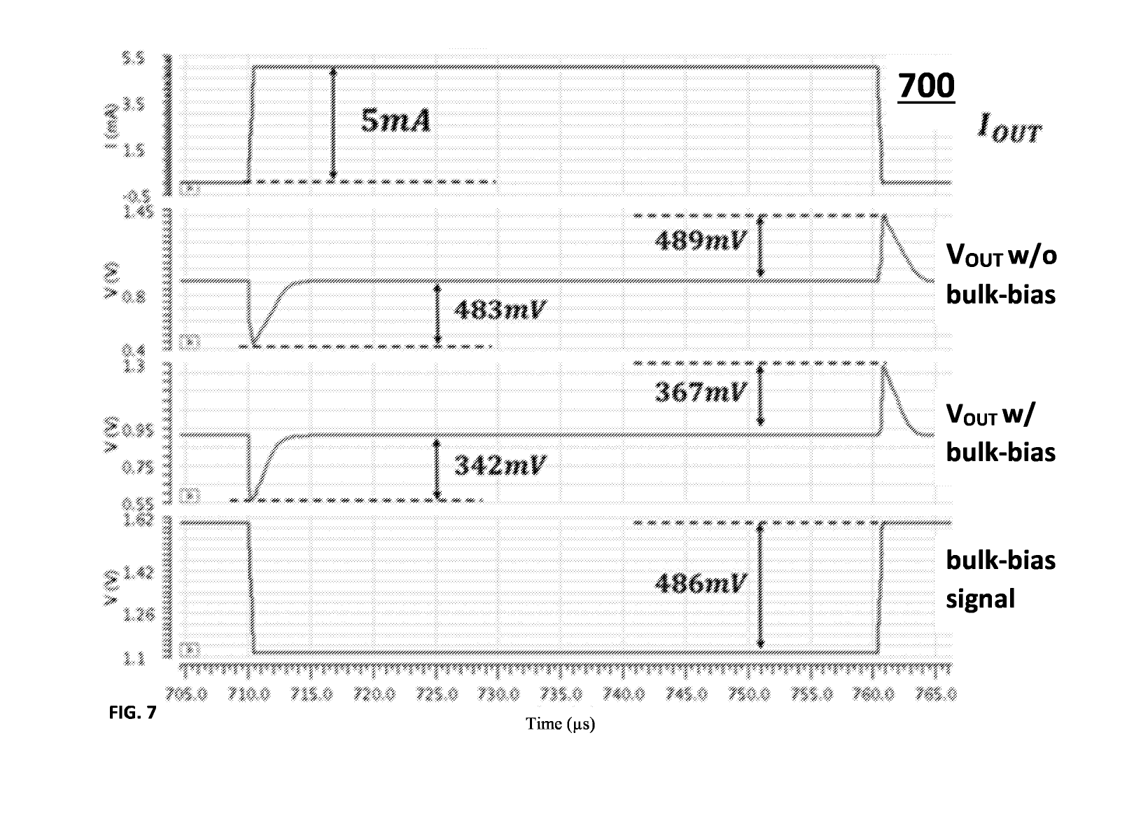

FIG. 7 shows simulation results from a comparison between a conventional non-bulk bias LDO and an adaptive bulk-biased LDO in accordance with embodiments of the invention. In this simulation, V_{IN} is 1.6V, V_{OUT} is 0.9V, I_{OUT} changes from 1 μA to 5 mA within 400 ns. The adaptive bulk-bias voltage changes with I_{OUT}. V_{SB} of the pass device of the bulk-biased LDO regulator is 0 when I_{OUT} is 0, and it reaches 486 mV when I_{OUT} is 5 mA. For the non-bulk bias LDO, when there is a load current change, the overshoot and undershoot of the output voltage are 489 mV and 483 mV, respectively. If an adaptive bulk-bias is added to the pass device, the overshoot and undershoot values can be reduced to 367 mV and 342 mV, respectively.

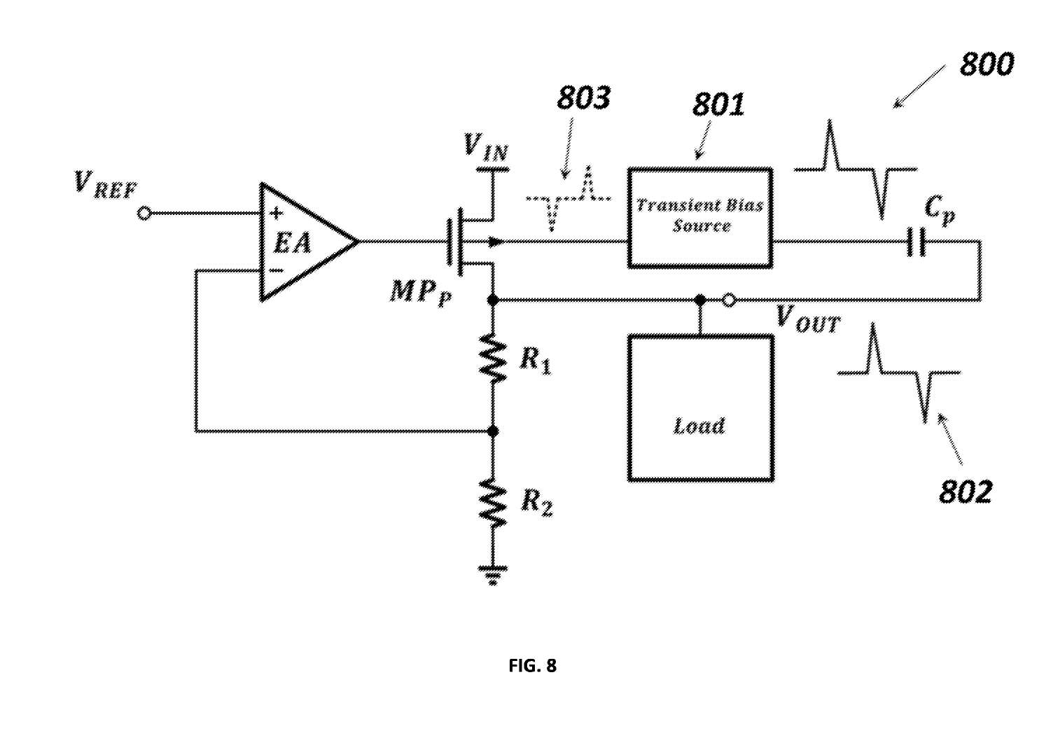

Another way to improve the load transient performance is to add a transient adaptive bulk-bias signal through a fast feedback path (e.g. faster than 1 μs) from the output of the regulator. FIG. 8 shows a possible implementation (800) using a transient bias source (801). The negative and positive spikes (802) of the output signal V_{OUT} are sensed and used to trigger the transient bias source 801 to generate a transient bulk-biased voltage (803). In this way, the bulk-bias is only added during the load transitions.

The circuits described above are implementation examples. Same methods and/or ideas may be applied to voltage regulators (switching and linear) using different pass devices (such as PMOS, NMOS, PFET, NFET, PFIN, and NFIN, wherein P and N denotes p-type and n-type, MOS refers to metal-oxide-semiconductor, FET refers to field-effect transistor, and FIN refers to fin field-effect transistor).

In accordance with embodiments of the invention, one or more of the modules and elements shown in the example of FIG. 8 may be omitted, repeated, and/or substituted. Accordingly, embodiments of the invention should not be considered limited to the specific arrangements of modules shown in the example of FIG. 8. One skilled in the art would appreciate that other modifications and variations are possible without departing from the scope of the invention.

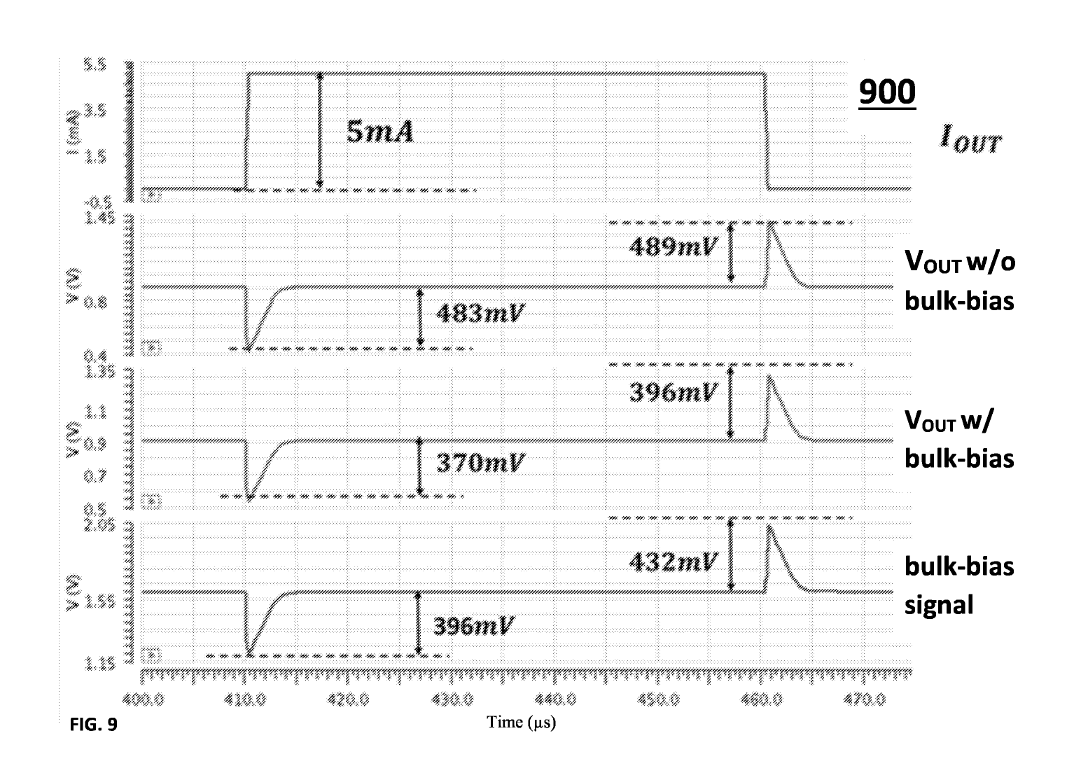

FIG. 9 shows simulation results of an implementation, as shown in FIG. 8, that includes transient adaptive bulk bias to improve the load transient performance. In this simulation, V_{IN} is 1.6V, V_{OUT} is 0.9V, I_{OUT} changes from 1 μA to 5 mA within 400 ns. The bulk-bias is added only when the negative and positive spikes occur at the output of the LDO regulator. The overshoot and undershoot values are reduced by 93 mV and 113 mV, respectively, in this example.

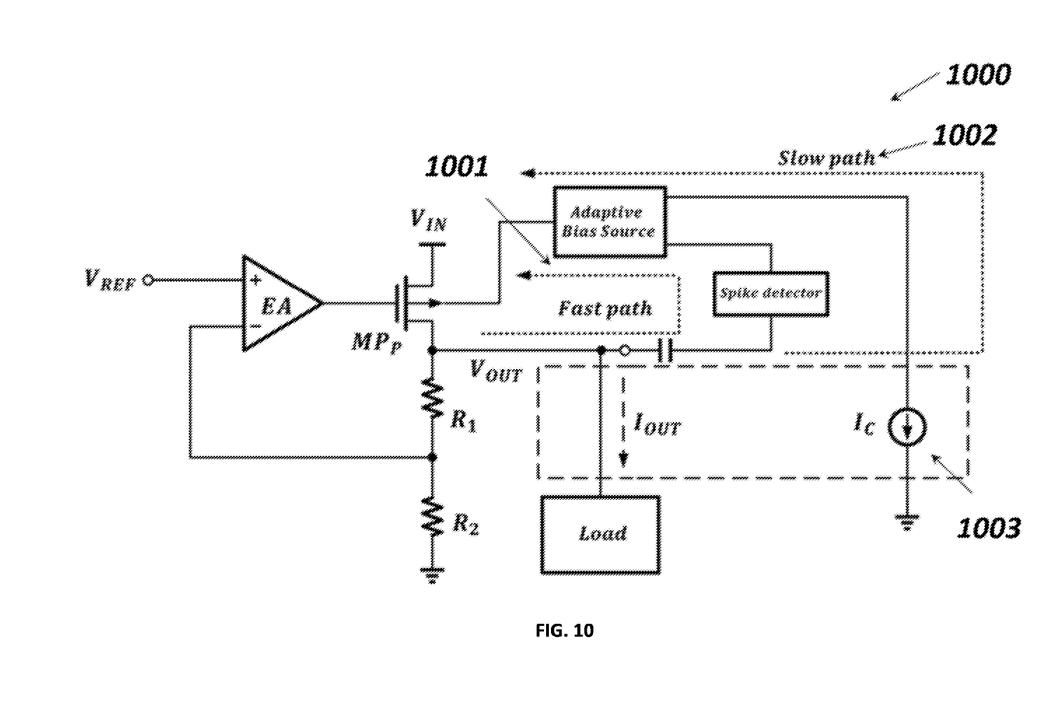

As noted above, FIG. 8 shows one exemplary implementation that includes a transient adaptive bulk bias. However, other modifications and variations are possible. For example, FIG. 10 shows an LDO regulator with a combinational adaptive bulk-bias design that includes a fast path (1001) and a slow path (1002, e.g. slower than 0.1 ms). The fast path detects the transient changes of the output voltage level, and it provides bulk-bias signals to the pass device only when there is a spike in the output voltage. The slow path senses the load current of the LDO regulator through a current sensor (e.g., a current controlled current source) (1003), and it provides a bulk-bias signal that is proportional to the magnitude of the DC load current. The bulk-bias signals from both fast and slow paths are combined to generate a comprehensive bulk-bias signal to the pass device. In this way, the load transient response of the LDO regulator can be further improved.

The circuit shown in FIG. 10 is just an implementation example. Same method and/or idea may be applied to voltage regulators (switching and linear) using different pass devices (PMOS, NMOS, PFET, NFET, PFIN, and NFIN).

In accordance with embodiments of the invention, one or more of the modules and elements shown in the example of FIG. 10 may be omitted, repeated, and/or substituted. Accordingly, embodiments of the invention should not be considered limited to the specific arrangements of modules shown in the example of FIG. 10.

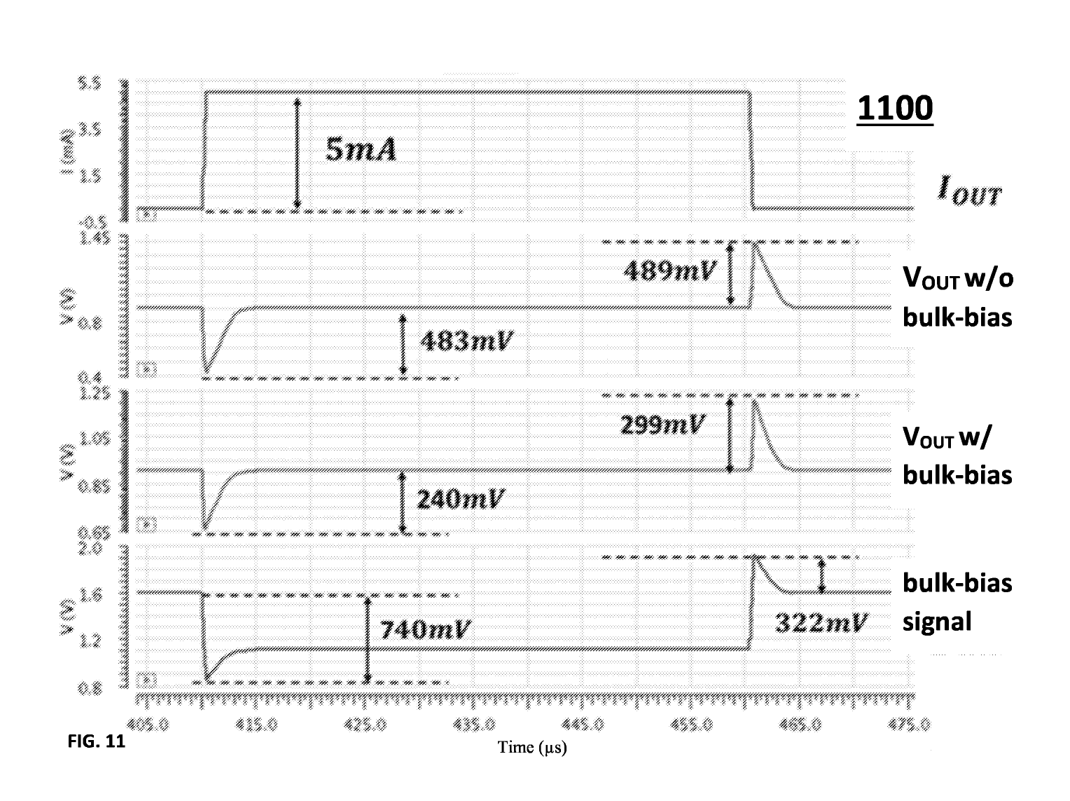

FIG. 11 shows simulation results of load transient response improvement by adding a combinational adaptive bulk-bias to the LDO regulator. In this simulation, V_{IN} is 1.6V, V_{OUT} is 0.9V, I_{OUT} changes from 1 μA to 5 mA within 400 ns. In the slow path, the adaptive bulk-bias voltage changes with I_{OUT}. V_{SB} of the pass device of the bulk-biased LDO regulator is 0 when I_{OUT} is 0, and it reaches 486 mV when I_{OUT} is 5 mA. In the fast path, the negative and positive spikes of the output voltage are detected and used to generate transient bulk-bias signals to the pass device. The overshoot and undershoot values are reduced by 190 mv and 243 mV, respectively, in this example.

Advantages of embodiments of the invention may include one or more of the following: Embodiments of the invention, by applying adaptive bulk-bias technique to the pass device (or power device) of a voltage regulator that changes its voltage value with the regulator output current. In addition, implementation of a fast transient path that changes the bulk-bias of the pass device (or power device) instantaneously as a result of an instantaneous change in the output current and output voltage of the regulator. Moreover, a combination of both techniques is presented.

Embodiments of the invention have been illustrated with a limited number of examples. One skilled in the art would appreciate that other variations and modifications are possible without departing from the scope of the invention. Therefore, the scope of protection of this invention should only be limited by the appended claims.

1. A low-dropout (LDO) voltage regulator, comprising:
an adaptive bias source for generating a bulk-bias signal to a pass device in the LDO voltage regulator,
wherein the adaptive bias source generates the bulk-bias signal based on a signal obtained at an output of the LDO voltage regulator, wherein the signal is obtained with a current controlled current source that senses a load current of the LDO voltage regulator.

2. The LDO voltage regulator according to claim 1, wherein the signal comprises a current signal that is proportional to a current at the output of the LDO voltage regulator.

3. The LDO voltage regulator according to claim 1, wherein the signal comprises a feedback signal from a feedback path connected between the adaptive bias source and the output of the LDO voltage regulator for sensing a negative spike, a positive spike, or a negative and a positive spikes.

4. The LDO voltage regulator according to claim 1, wherein the signal comprises a current signal, which is proportional to a current at the output of the LDO voltage regulator, and a feedback signal from a feedback path connected between the adaptive bias source and the output of the LDO voltage regulator for sensing a negative spike, a positive spike, or a negative and a positive spikes.

5. The LDO voltage regulator according to claim 1, wherein the pass device is one selected from the group consisting of PMOS, NMOS, PFET, NFET, PFIN, and NFIN.

6. The LDO voltage regulator according to claim 2, wherein the pass device is one selected from the group consisting of PMOS, NMOS, PFET, NFET, PFIN, and NFIN.

7. The LDO voltage regulator according to claim 3, wherein the pass device is one selected from the group consisting of PMOS, NMOS, PFET, NFET, PFIN, and NFIN.

8. The LDO voltage regulator according to claim 4, wherein the pass device is one selected from the group consisting of PMOS, NMOS, PFET, NFET, PFIN, and NFIN.

9. A method for voltage regulation using a low dropout (LDO) voltage regulator that comprises an adaptive bias source connected to a pass device and a controlled current source for sensing a load current of the LDO voltage regulator, the method comprising:
sensing a signal at an output of the LDO voltage regulator, using the controlled current source, and providing the signal to the adaptive bias source;
generating a bulk-bias signal from the adaptive bias source based on a magnitude of the signal sensed at the output; and
supplying the bulk-bias signal to the pass device.

10. The method according to claim 9, wherein the signal comprises a current signal that is proportional to a current at the output.

11. The method according to claim 9, wherein the signal comprises a feedback signal that relates to a negative spike, a positive spike, or a negative and a positive spikes at the output.

12. The method according to claim 9, wherein the signal comprises a current signal, which is proportional to a current at the output, and a feedback signal that relates to a negative spike, a positive spike, or a negative and a positive spikes at the output.
